(19) United States
(12) Patent Application Publication
(10) Pub. No.: US 2024/0000099 A1
(43) Pub. Date: Jan. 4, 2024

(54) GELLED CONFECTION COMPRISING HMO

(71) Applicant: DSM IP Assets B.V., Heerlen (NL)

(72) Inventors: Gabriela BADOLATO BÖNISCH, Kaiseraugst (CH); Jovana POEPELT, Kaiseraugst (CH); Paulo Henrique SANTOS, Kaiseraugst (CH); Gang SU, Kaiseraugst (CH); Isaac TENLLADO, Kaiseraugst (CH); Eric TOGLIA, Kaiseraugst (CH); Lori VAN-TASSEL, Kaiseraugst (CH); Dirk Oliver WOERNE, Kaiseraugst (CH)

(21) Appl. No.: 18/253,544

(22) PCT Filed: Nov. 12, 2021
(86) PCT No.: PCT/EP2021/081525

§ 371 Date: May 18, 2023

Related U.S. Application Data
(60) Provisional application No. 63/116,526, filed on Nov. 20, 2020.

(30) Foreign Application Priority Data
Dec. 28, 2020 (CH) 1675/20

(51) Int. Cl. A23G 3/42; A23G 3/50; A23L 33/10

(52) U.S. Cl. CPC A23G 3/42; A23G 3/50; A23L 33/10

(57) ABSTRACT

The present invention relates to a new formulation, which is a gelled confection, which comprises at least one Human Milk Oligosaccharides (HMOs).

The present invention relates to a new formulation, which is a gelled confection, which comprises at least one Human Milk Oligosaccharides (HMOs).

Gelled confections in the context of the present invention are confections such as gummy candies, jellies, gummy bears, (wine) gums etc. Such gelled confections are popular among consumers because they have an elastic texture and they can be relatively easily flavored with a texture-matching flavor. Among the jellies, gummi candies are particularly popular for the chewy, elastic texture.

Gelled confections (such as i.e. gummy bears) are usually made from a mixture of sugars (e.g. glucose syrup, sucrose, dextrose, others), a gelling ingredient or combination (e.g. starch, gelatin, pectin and others hydrocolloids), flavoring, food coloring and citric acid. However, recipes vary, such as organic candy, those suitable for vegetarians, or those following religious dietary laws.

Gelled confections made with bovine, porcine or piscine gelatin are not suitable for vegetarians and vegans. Also, some gelled confections are made with pectin, starch or other hydrocolloids (e.g. gellan gum) instead of gelatin, making the gelled confections suitable for vegetarians.

Furthermore, gelled confections can also be delivery systems for healthy ingredients (such as for example vitamins, minerals, PUFAs etc.), because gelled confections are very attractive especially for younger people or for people who do not like to swallow regular tablets.

Gelled (or gummy) confections can have a variety of forms, such as gelled bears, gelled worms, gelled frogs, gelled hamburgers, gummy cherries, gelled soda bottles, gelled sharks, gelled army men, gelled hippopotami, gelled lobsters, gelled watermelons, gelled octopuses, gelled apples, gelled peaches, and gelled oranges and many more. Also the sizes of the gelled confection can vary.

But as it can be seen from the ingredients listed above a traditional gelled confection comprises a significant amount of all sorts of sugar.

Sugar is known for causing weight gain, increasing risk of diabetes, increasing cellular aging, dental issues etc.; and sugar alcohols may cause gastrointestinal symptoms. It has been really important to reduce the usage level of any sugar (or sugar alcohols) in confectioneries to produce healthier products for consumers. However, it is often very challenging to reduce the usage level of sugar while still maintaining a good texture. A good texture as well as nice taste (in that case sweetness) is an important property for the consumers.

The goal of the present invention is to find a way to reduce the regular sugar (also known as white sugar, table sugar or granulated sugar), which is refined sucrose (a disaccharide) and/or other types of sugars (also known as dextrose, high fructose corn syrup, others).

Surprisingly, it was found when at least one HMO in a specific amount (a specific range) is used, then it is possible to reduce the regular sugar significantly without having any negative effect on the properties of the gelled confection (such as taste, texture, stability). It is even possible to produce gelled confection without any sugar.

Therefore, the present to a gelled confection (GC) comprising
(i) at least one gelling substance (such as pectin, starch, gelatin, or other hydrocolloids), and
(ii) water, and
(iii) at least 0.1-60 wt-%, based on the total weight of the gelled formulation, of at least one HMO and
   which has a water moisture content of more than 8 wt-%, based on the total weight of the gelled confection.

All ingredients always add up to 100.

The gelled confection according to the present invention is essentially free of sialic acid. This means that no sialic acid is added to the gelled confection according to the present invention.

Therefore, the present invention relates to a gelled confection (GC′), which is the gelled confection (GC), which is (essentially) free of sialic acid.

The water moisture content of the gelled confection according to the present invention is preferably between 8 and 50 wt-%, based on the total weight of the gelled confection. Preferably, the water moisture content of the gelled confection is in the range of 10 wt-% to 45 wt-%, based on the total weight of the gelled confection.

Therefore, the present invention relates to a gelled confection (GC1), which is the gelled confection (GC) or (GC′) having a water moisture content of between 8 and 50 wt-%, based on the total weight of the gelled confection.

Therefore, the present invention relates to a gelled confection (GC1′), which is the gelled confection (GC) or (GC′) having a water moisture content of between 10 and 45 wt-%, based on the total weight of the gelled confection.

Due to the addition of the HMO (or mixture of HMO), the amount of sugar (or sugar alcohols) in the gelled confection can be reduced significantly.

Human milk oligosaccharides (HMOs) are a family of structurally diverse unconjugated glycans that are highly abundant in and unique to human milk. Originally, HMOs were proposed to be prebiotic “bifidus factors,” or human milk glycans found to promote growth in Bifidobacterial species of the gut and found uniquely in the stool of breast fed infants compared to formula fed infants.

HMOs are composed of the five monosaccharides glucose (Glc), galactose (Gal), N-acetylglucosamine (GlcNAc), fucose (Fuc) and sialic acid (Sia), with N-acetylneuraminic acid (Neu5Ac) as the predominant if not the only form of Sia. More than two hundred different HMOs have been identified so far. The most important ones are 2′-fucosyllactose (2′ FL), lacto-N-neotetraose (LNnT), 3-fucosyllactose (3FL), difucosyllactose (DFL), Lacto-N-fucopentaose I (LNFP I), 3″Sialyllactose Sodium Salt (3′SL), 6″Sialyllactose Sodium Salt (6′SL), and Lacto-N-Tetraose (LNT).

HMOs can be isolated from breast milk or they can be produced chemically or biochemically. HMOs are available commercially from a variety of producers.

For the purpose of the present invention the source of the HMO is not essential. It is clear that HMOs from different sources can be used.

Several studies have reported the health benefits of HMOs, which include modulation of the intestinal microbiota, anti-adhesive effect against pathogens, modulation of the intestinal epithelial cell response, and development of the immune system.

Therefore, HMOs have very positive effect when consumed by humans and/or animals. In the embodiment of the present invention the HMO does not only serve as active ingredient with a health benefit for humans and animals, but it has also as stated above a positive effect on the property of the gelled confection.

Therefore, the present invention relates to a gelled confection (GC2), which is the gelled confection (GC), (GC′), (GC1) or (GC1′), wherein the at least one HMO is chosen from the group consisting of 2′-fucosyllactose (2′ FL), lacto-N-neotetraose (LNnT), 3-fucosyllactose (3FL), difucosyllactose (DFL), Lacto-N-fucopentaose I (LNFP I), 3″Sialyllactose Sodium Salt (3′SL), 6″Sialyllactose Sodium Salt (6′SL), and Lacto-N-Tetraose (LNT).

Therefore, the present invention relates to a gelled confection (GC2′), which is the gelled confection (GC), (GC′), (GC1) or (GC1′), wherein the at least one HMO is chosen from the group consisting of 2′-fucosyllactose (2′ FL), lacto-N-neotetraose (LNnT), 3-fucosyllactose (3FL), difucosyllactose (DFL), Lacto-N-fucopentaose I (LNFP I), and Lacto-N-Tetraose (LNT).

The amount of the at least one HMO is 0.1-60 wt-%, based on the total weight of the gelled confection. (Preferably 5-55 wt-%, more preferably 10-55 wt-%, especially preferred 15-50 wt-%, based on the total weight of the gelled confection).

Therefore, the present invention relates to a gelled confection (GC3), which is the gelled confection (GC), (GC′), (GC1), (GC1′), (GC2) or (GC2′), wherein the content of the at least one HMO is 5-55 wt-%, based on the total weight of the gelled confection.

Therefore, the present invention relates to a gelled confection (GC3′), which is the gelled confection (GC), (GC′), (GC1), (GC1′), (GC2) or (GC2′), wherein the content of the at least one HMO is 10-55 wt-%, based on the total weight of the gelled confection.

Therefore, the present invention relates to a gelled confection (GC3″), which is the gelled confection (GC), (GC′), (GC1), (GC1′), (GC2) or (GC2′), wherein the content of the at least one HMO is 15-50 wt-%, based on the total weight of the gelled confection.

The gelled formulation according to the present invention also comprises at least one gelling substance.

Any commonly known gelling substance (or mixture of gelling substances), which are usually used in such gelled confections, can be used.

Suitable gelling substance are gelatine (from any source), pectin (from any sources), starches (from any sources), other hydrocolloids (from any sources).

Therefore, the present invention relates to a gelled confection (GC4), which is the gelled confection (GC), (GC′), (GC1), (GC1′), (GC2), (GC2′), (GC3), (GC3′) or (GC3″), wherein the at least one gelling substance is chosen from the group consisting of gelatine, pectin, starches and hydrocolloids.

The amount of the gelling substance in the gelled confection is usually (and preferably) between 0.5 and 20 wt-%, based on the total weight of the gelled confection. Preferably 0.5 to 10 wt %, based on the total weight of the gelled confection.

Therefore, the present invention relates to a gelled confection (GC5), which is the gelled confection (GC), (GC′), (GC1), (GC1′), (GC2), (GC2′), (GC3), (GC3′), (GC3″) or (GC4), wherein the content of the at least one gelling substance is between 0.5 and 20 wt-%, based on the total weight of the gelled confection.

Furthermore, the gelled confection according to the present invention can also comprise sugar. But as stated above is possible to produce Gelled confection without any sucrose (or sugar alcohol or other types of sugars). This means that no sucrose (or sugar alcohol or other types of sugar) is added to the gelled confection intentionally. It might be that traces of sugar are present.

Therefore, the present invention relates to a gelled confection (GC6), which is the gelled confection (GC), (GC′), (GC1), (GC1′), (GC2), (GC2′), (GC3), (GC3′), (GC3″), (GC4) or (GC5), wherein the gelled confection is (essentially) free of sugar and sugar alcohol.

It is possible, if wished, to add sucrose and/or sugar alcohol and/or other types of sugars (also known as dextrose, corn syrup, high fructose corn syrup, etc). But the content of sucrose and/or sugar alcohols and/or other sugars is much lower than in conventional gelled confection.

In such cases the amount of sucrose and/or sugar alcohols and/or other sugars is from 1-85 wt-%, based on the total weight of the gelled confection. Preferably up to 70 wt-%, based on the total weight of the gelled confection.

Therefore, the present invention relates to a gelled confection (GC7), which is the gelled confection (GC), (GC′), (GC1), (GC1′), (GC2), (GC2′), (GC3), (GC3′), (GC3″), (GC4) or (GC5), wherein the gelled confection is comprises 1-85 wt-%, based on the total weight of the gelled confection, of sucrose and/or sugar alcohol and or other types of sugar.

The gelled confection according to the present invention can also, but necessarily mandatory, comprise citric acid and/or other acids (also known as malic acid, etc). Usually in an amount of 0.1 to 10 wt-%, based on the total weight of the gelled confection.

Therefore, the present invention relates to a gelled confection (GC8), which is the gelled confection (GC), (GC′), (GC1), (GC1′), (GC2), (GC2′), (GC3), (GC3′), (GC3″), (GC4), (GC5), (GC6) or (GC7), wherein the gelled confection comprises citric acid and/or other acids.

Therefore, the present invention relates to a gelled confection (GC8′), which is the gelled confection (GC8), wherein the amount of citric acid and/or other acid is between 0.1 to 10 wt-%, based on the total weight of the gelled confection.

Usually, the gelled confection according to the present invention comprises at least one flavour ingredient as well. Such flavour can be natural ones as well as artificial ones (as well as a mixture thereof).

The amount of such flavour ingredients can vary also due to the different intensity of flavour ingredients. Usually the amount of such flavour ingredients is less than 2 wt-%, based on the total weight of the gelled confection. Preferably the amount is 0.01 to 1 wt-%, based on the total weight of the gelled confection.

Therefore, the present invention relates to a gelled confection (GC9), which is the gelled confection (GC), (GC′), (GC1), (GC1′), (GC2), (GC2′), (GC3), (GC3′), (GC3″), (GC4), (GC5), (GC6), (GC7), (GC8) or (GC8′), wherein the gelled confection comprises at least one flavour ingredient.

Therefore, the present invention relates to a gelled confection (GC9′), which is the gelled confection (GC9), wherein the content of the at least one flavour ingredient is 0.01 to 1 wt %, based on the total weight of the gelled confection.

It is very common that the gelled confection has a colour, which fits to the flavour. Therefore, it is very common to add at least one colouring agent to the gelled confection according to the present invention. The colouring agent can be natural ones as well as artificial ones (as well as a mixture thereof).

The amount of such colouring agent can vary also due to the different colour intensity. Usually, the amount of such colouring agent is less than 1 wt-%, based on the total weight of the gelled confection. Preferably the amount is 0.01 to 1 wt-%, based on the total weight of the gelled confection.

Therefore, the present invention relates to a gelled confection (GC10), which is the gelled confection (GC), (GC′), (GC1), (GC1′), (GC2), (GC2′), (GC3), (GC3′), (GC3″), (GC4),

(GC5), (GC6), (GC7), (GC8), (GC8′), (GC9) or (GC9′), wherein the amount of the colouring agent is 0.01 to 1 wt-%, based on the total weight of the gelled confection.

The gelled confection according to the present invention can comprise further (non-essential) ingredients, such as pH buffers, antioxidants, divalent salts (such as Ca salt), etc. Such additional ingredients may be present in the amount of up to 10 wt-%, based on the total weight of the gelled confection.

Therefore, the present invention relates to a gelled confection (GC11), which is the gelled confection (GC), (GC′), (GC1), (GC1′), (GC2), (GC2′), (GC3), (GC3′), (GC3″), (GC4), (GC5), (GC6), (GC7), (GC8), (GC8′), (GC9), (GC9′) or (GC10), wherein the gelled confection comprises further (non-essential) ingredients chosen form the group consisting of pH buffers, antioxidants and divalent salts (such as Ca salt).

Therefore, the present invention relates to a gelled confection (GC11′), which is the gelled confection (GC11), wherein the amount of the further (non-essential) ingredients is up to 10 wt-%, based on the total weight of the gelled confection.

Furthermore, the gelled confection according to the present invention can also comprise further active ingredients (next to the HMOs).

Preferred active ingredients for the embodiment of the present invention may include vitamins, nutritional lipids, minerals, nutraceuticals, glycosaminoglycan or its active members, amino acids or combination thereof that are useful in human or animal nutrition. preferably include vitamins, minerals, glycosaminoglycan or its active members and amino acids.

Such additional active ingredients may be present in amount of up to 10 wt-%, based on the total weight of the gelled confection.

Therefore, the present invention relates to a gelled confection (GC12), which is the gelled confection (GC), (GC′), (GC1), (GC1′), (GC2), (GC2′), (GC3), (GC3′), (GC3″), (GC4), (GC5), (GC6), (GC7), (GC8), (GC8′), (GC9), (GC9′), (GC10), (GC11) or (GC11′), wherein the gelled confection comprises at least one further active ingredient (next to the HMOs).

Therefore, the present invention relates to a gelled confection (GC12′), which is the gelled confection (GC12), wherein the at least one further active ingredient is chosen from vitamins, nutritional lipids, minerals, nutraceuticals, glycosaminoglycan or its active members, amino acids.

Therefore, the present invention relates to a gelled confection (GC12″), which is the gelled confection (GC12) or (GC12′), wherein the at least one further active ingredient is present in amount of up to 10 wt-%, based on the total weight of the gelled confection.

The gelled confection of the invention may be packaged individually for administration and stable storage and then usually packed in a larger container. But it may also be possible not to pack them individually and then put them as such in a container.

A general way to produce the formulation according to the present invention is the following:

Typically, the gelled confections according to the present invention are generally produced as follows:

Sugar Containing Gelled Confection:

Mix sugar, sugar alcohols and water and heat it.

Then add the gelling substance (or mixture of gelling substances) and dissolve it into the mixture. One may pre-hydrate the gelling substances before dissolving into the mixture. Then add the HMO (as solution), colour, flavour and citric acid and all other ingredients To make the shape, a form is pressed in a tray of corn starch or silicon mold and the liquid candy mixture is put into it and let them dry.

Sugarless Gelled Confection:

Mix the gelling substance and water and heat it.

then add the HMO (as solution), colour, flavour and citric acid and all other ingredients To make the shape, a form is pressed in a tray of corn starch or silicon mold and the liquid candy mixture is put into it and let them dry.

The following examples serve to illustrate the invention.

### EXAMPLES

### Example 1

1. Blend the gellan gum and dicalcium phosphate anhydrous with 1.0 g of sodium citrate dihydrate and 40 g of sucrose and disperse in the deionized water I.

2. Heat to boiling to hydrate the gellan gum

3. Add the remainder of the sugar and half of the HMO (predissolved in deionized water II)

4. Pre-warm glucose syrup and add to the hot solution.

5. Add the remainder of HMOs.

4. Cook the liquor to 80±82% total solids then cool to 90° C.

5. Dissolve the citric acid and remainder of sodium citrate, color and flavor in Deionized water III and stir into the liquor.

6. Deposit at 76% total solids into several starch molds.

7. Dry at ambient temperature for 72 hours.

TABLE 1
gelled confections of example 1

| Ingredients | Amount [g] |
|---|---|
| Sucrose | 109.1 |
| Glucose syrup 80%, DE~42 | 109.1 |
| Low Acyl Gellan Gum | 8.9 |
| Citric acid | 11.9 |
| Dicalcium phosphate anhydrous | 0.73 |
| Tri sodium citrate anhydrous | 10.38 |
| HMO, 2′-Fucosyllactose (2′FL) | 535 |
| Flavour & Colours | q.s |
| Deionized water I | 383.4 |
| Deionized water II | 80 |
| Deionized water III | 50 |
| Total non cooked | 1300 |
| Yield approximately (at depositing) | 1000 |

### Example 2

1. Hydrate pectin (sodium citrate) at 80-85° C. for 30 min (Powder to water ratio=1:10, 17.6 g pectin+176 g water).

2. Boil B (sugar, water, corn syrups) to 110° C. (set to 250° C.)

3. Dissolve HMO into water at 1:0.5 ratio (400 g HMO+200 g water) and hydrate for 5 min. Mix HMO into part B, then Pectin solution, heat to 100° C. and keep for 5 min.

4. At 90 C, add citric acid/stock solution (color)/flavor and mix well until homogeneous.

5. Deposit into several silicone and starch molds.

6. Remove from mold and polish with carnauba wax after 24 hours.

TABLE 2
gelled confections of example 2

| Ingredients | Amount [g] |
|---|---|
| Pectin 64030 | 19.2 |
| Water | 361.92 |
| Citric acid | 4 |
| Orange flavor | 4 |
| CaroCare BC 10% CWS/S (1% solution) | 8 |
| HMO, 2′-Fucosyllactose (2′FL) | 400 |
| Reb M | 0.32 |
| sodium citrate | 2.56 |

### Example 3

The gelled confection of example 3 had been made in analogy of Example 1.

TABLE 3
Gelled confections (gummi bears) of example 3

| Ingredients | Amount [g] |
|---|---|
| Sucrose | 38.00 |
| Glucose Syrup 80%, DE 42 | 30.00 |
| HMO, 2′-Fucosyllactose (2′FL) | 12.00 |
| Pectin (high methoxy for confectionary) | 2.00 |
| Citric Acid 50% w/w | 1.20 |
| Ascorbic acid fine powder | 0.25 |
| Dry Vitamin D3 100 SD/S (10% solution) | 0.27 |
| Orange flavor | 0.08 |
| CaroCare BC 10% CWS/S (1% solution) | 1.20 |
| water | 15.00 |

### Example 4

1. Hydrate gelatin/pectin at 80 C for 1 hr (Powder to water ratio=1:2, 26 g gelatin/52 g water). 1:10 for pectin, 8 g pectin+80 g water

2. Boil B (sugar, water, corn syrups) to 110° C. (set to 250° C.)

3. Dissolve HMO into water at 1:0.35 ratio (264 g HMO+92 g water). Mix gelatin/HMO into part B, heat to 100° C. and keep for 5 min. (Brix 78)

4. At 90° C., add citric acid/stock solution (color)/flavor and mix well until homogeneous.

5. Deposit into several silicone molds.

6. Remove from mold and polish with carnauba wax after 24 hours.

TABLE 4
Gelled confection of example 4

| Ingredients | Amount [g] |
|---|---|
| Pork Gelatin | 25.6 |
| Pectin 64030 | 8 |
| Water | 100.4 |
| Sugar | 248 |
| 63 DE Corn syrup | 134 |
| Citric acid | 8 |
| Orange flavor | 4 |
| CaroCare BC 10% CWS/S (1% solution) | 8 |
| HMO, 2′-Fucosyllactose (2′FL) | 264 |

1. Gelled confection comprising
(i) at least one gelling substance, and
(ii) water, and
(iii) at least 0.1-60 wt-%, based on the total weight of the gelled formulation, of at least one HMO, and
which has a water moisture content of more than 8 wt-%, based on the total weight of the gelled confection.

2. Gelled confection according to claim 1, which is free of sialic acid.

3. Gelled confection according to claim 1 having a water moisture content of between 8 and 50 wt-%, based on the total weight of the gelled confection.

4. Gelled confection according to claim 1, wherein the at least one HMO is chosen from the group consisting of 2′-fucosyllactose (2′ FL), lacto-N-neotetraose (LNnT), 3-fucosyllactose (3FL), difucosyllactose (DFL), Lacto-N-fucopentaose I (LNFP I), 3′Sialyllactose Sodium Salt (3′SL), 6′Sialyllactose Sodium Salt (6′SL), and Lacto-N-Tetraose (LNT).

5. Gelled confection according to claim 1, wherein the content of the at least one HMO is 0.1-60 wt-%, based on the total weight of the gelled confection.

6. Gelled confection according to claim 1, wherein the at least one gelling substance is chosen from the group consisting of gelatine, pectin, starches, and other hydrocolloids.

7. Gelled confection according to claim 1, wherein the content of the at least one gelling substance is between 0.5 and 20 wt-%, based on the total weight of the gelled confection.

8. Gelled confection according to claim 1, wherein the gelled confection is (essentially) free of sugars and sugar alcohol.

9. Gelled confection according to claim 1, wherein the gelled confection comprises 1-85 wt-%, based on the total weight of the gelled confection, of sugar and/or sugar alcohol.

10. Gelled confection according to claim 1 comprising citric acid or other acid.

11. Gelled confection according to claim 10, wherein comprising 0.1 to 10 wt-%, based on the total weight of the gelled confection, of citric acid or other acid.

12. Gelled confection according to claim 1, wherein the gelled confection comprises at least one flavour ingredient.

13. Gelled confection according to claim 1, wherein the gelled confection comprises at least one colouring agent.

14. Gelled confection according to claim 13, wherein the amount of the colouring agent is 0.01 to 1 wt-%, based on the total weight of the gelled confection.

15. Gelled confection according to claim 1, wherein the gelled confection comprises further active ingredients chosen from the group consisting of vitamins, nutritional lipids, minerals, nutraceuticals, glycosaminoglycan or its active members, amino acids or combination thereof that are useful in human or animal nutrition. preferably include vitamins, minerals, glycosaminoglycan or its active members and amino acids.
